(19) United States
(12) Patent Application Publication
(10) Pub. No.: US 2004/0102587 A1
(43) Pub. Date: May 27, 2004

(54) Hydrophilic polymer membranes made of single phase polymer blends comprising polysulfones and hydrophilic copolymers

(75) Inventors: Chang-Keun Kim, Seoul (KR); Joo-Heon Kim, Seoul (KR); Sang-Bong Seo, Seongnam-city (KR); Hyung-Ja You, Seongnam-city (KR)

Correspondence Address: VOLPE AND KOENIG, P.C., UNITED PLAZA, SUITE 1600, 30 SOUTH 17TH STREET, PHILADELPHIA, PA, 19103, US

(73) Assignees: Chung Ang University, Seoul (KR); Chang-Keun Kim, Seoul (KR); Joo-Heon Kim, Seoul (KR)

(21) Appl. No.: 10/464,588

(22) Filed: Jun. 18, 2003

(30) Foreign Application Priority Data
Nov. 27, 2002 (KR) 2002-74465

(51) Int. Cl. C08G 75/20

(52) U.S. Cl. 525/535

(57) ABSTRACT

A polymer membrane having a first surface and a second surface, wherein the polymer membrane has a reticulated network of flow channels between pores on the first and second surfaces, and is made of a single phase blend containing a polysulfone polymer and a poly(vinylpyrrolidone-co-styrene) copolymer, the content of the poly(vinylpyrrolidone-co-styrene) copolymer contained in the polymer membrane being such that the poly(vinylpyrrolidone-co-styrene) copolymer can form the single phase blend with the polysulfone polymer.

### BACKGROUND OF THE INVENTION

This application claims the priority of Korean Patent Application No.2002-74465, filed on Nov. 27, 2002, in the Korean Intellectual Property Office, the disclosure of which is incorporated herein in its entirety by reference.

1. Field of the Invention

The present invention relates to hydrophilic polymer membranes made of single phase polymer blends comprising polysulfones and hydrophilic copolymers. More particularly, the invention relates to hydrophilic polymer membranes made of single phase polymer blends comprising polysulfone polymers and poly(vinylpyrrolidone-co-styrene) copolymers useful as filtration membranes.

2. Description of the Related Art

Contamination of various water resources by organic compounds, heavy metals or salts is a major problem in terms of environments, human health and economy. Various separation technologies have been developed for treatment of industrial wastes, municipal sewages or service water. Currently, most separation technologies utilize adsorption, extraction, distilled separation and the like, which have, however, several problems including high facility investment and/or excessive energy consumption. Therefore, much attention has been paid to filtration technology using polymer membranes with small energy consumption and low facility investment and being environmentally friendly.

Conventionally, polysulfone polymer membranes having good mechanical, thermal, chemical properties and high solute removing capability have been widely used as filtration membranes for water treatment. However, contamination of polysulfone polymer membranes by fouling due to low water permeability and hydrophobic interactions with solutes has become a serious problem.

To overcome the hydrophobicity problems of polysulfone polymer membranes, one attempt for providing the polymer membranes with hydrophilicity is to add hydrophilic polymers such as polyvinylpyrrolidones or polyethyleneglycols to the polysulfone polymer membranes, as disclosed in Cabasso, Israel et al, “Polysulfone hollow fibers, I., Spinning and Properties”, Journal of Applied Polymer Science, Vol. 20, pp. 2377-2394. However, according to this technique, because a hydrophilic polymer contained in the polysulfone polymer membranes is easily removed from the polysulfone polymer membranes due to water soluble property during manufacture and/or use of the polymer membranes, sufficiently high hydrophilicity cannot be provided to the polymer membrane, so that an effect of improving water permeability is unsatisfactory. Moreover, remaining hydrophilic polymers may create water contamination.

It is also known that water permeability of the polysulfone polymer membranes can be increased somewhat by making the membrane hydrophilic through plasma treatment. However, this method also involves a problem in that the polysulfone polymer membranes become chemically unstable.

Japanese Patent Laid-Open Publication No. Showa58-104910 discloses a method of fixing a hydrophilic polymer to the polysulfone membranes using a cross linking agent. However, this method involves several disadvantages including a complicated fixing process and poor chemical stability of the resultant polysulfone polymer membrane.

A hydrophilic polymer membrane made of a hydrophilic polymer, for example, polyvinylalcohol or cellulose acetate, has unsatisfactory thermal and/or chemical properties. Another disadvantages of a hydrophilic polymer membrane include poor initial separation efficiency, degradation in separation efficiency after repeated use, and a need for frequently performing cleaning steps, making it difficult to use the hydrophilic polymer as a filtration membrane.

### SUMMARY OF THE INVENTION

The present invention provides a polymer membrane having good solute removal efficiency, water permeability, and fouling resistance when it is used as a filtration membrane for water treatment by simply providing hydrophilicity while maintaining good mechanical, thermal and chemical properties which are advantages of polysulfone polymers.

According to an aspect of the present invention, there is provided a polymer membrane having a first surface and a second surface, the polymer membrane comprising a reticulated network of flow channels between pores on the first and second surface, and made of a single phase blend containing a polysulfone polymer and a poly(vinylpyrrolidone-co-styrene) copolymer, the content of the poly(vinylpyrrolidone-co-styrene) copolymer contained in the polymer membrane being such that the poly(vinylpyrrolidone-co-styrene) can form the single phase blend with the polysulfone polymer.

According to another aspect of the present invention, there is provided a filtering apparatus comprising a filter having the single phase polymer membrane and being advantageously used for untrafiltration, microfiltration or reverse osmosis.

At present, as far as the inventors of the present invention know, there are no single phase polymer blends containing a polysulfone polymer. However, the polymer membrane according to the present invention is made of a single phase blend containing a hydrophobic polysulfone polymer and a hydrophilic poly(vinylpyrrolidone-co-styrene) copolymer. Thus, the polymer membrane according to the present invention can overcome a hydrophobicity problem, which is a drawback occurring when water treatment is performed using the polysulfone polymer membrane, while maintaining good mechanical, thermal and chemical properties of polysulfone polymer materials. In other words, since the polymer membrane according to the present invention has good mechanical, thermal and chemical properties, which are advantages of polysulfone polymer materials, and excellent water permeability and fouling resistance of poly(vinylpyrrolidone-co-styrene) copolymers, it can be advantageously used as a filtration membrane for water treatment.

Therefore, according to the polymer membrane of the present invention, while maintaining good mechanical, thermal, chemical properties and solute removing efficiency of a polysulfone polymer membrane, drawbacks of the polysulfone polymer membrane, including low water permeability and degradation in performance after the use of a prolonged time, can be solved. The polymer membrane according to the present invention can be advantageously used as an ultrafiltration membrane, a microfiltration membrane, a supporting layer of a reverse osmosis composite membrane, and the like.

### BRIEF DESCRIPTION OF THE DRAWINGS

The above and other features and advantages of the present invention will become more apparent by describing in detail exemplary embodiments thereof with reference to the attached drawings in which:

FIG. 1 is a scanning electron micrograph of the cross section of a filtration membrane prepared from a casting solution containing polysulfone only;

FIG. 2 is a scanning electron micrograph of the cross section of a filtration membrane prepared from a casting solution containing polysulfone and a poly(vinylpyrrolidone-co-styrene) copolymer comprising 70 wt % of vinylpyrrolidone; and

FIG. 3 is a scanning electron micrograph of the cross section of a filtration membrane prepared from a casting solution containing polysulfone and a poly(vinylpyrrolidone-co-styrene) copolymer comprising 30 wt % of vinylpyrrolidone.

### DETAILED DESCRIPTION OF THE INVENTION

A polymer membrane according to the present invention and a preparation method thereof will now be described in detail.

The polymer membrane according to the present invention having a first surface and a second surface, has a reticulated network of flow channels between pores on the first and second surfaces, and made of a single phase blend comprising a polysulfone polymer and a poly(vinylpyrrolidone-co-styrene) copolymer, the content of the poly(vinylpyrrolidone-co-styrene) copolymer contained, being such that the poly(vinylpyrrolidone-co-styrene) copolymer can form a single phase with the polysulfone polymer.

In order to maintain good mechanical, thermal and chemical properties, including good solute removing efficiency, a high glass transition temperature and a high tensile strength, the polysulfone polymer is preferably one selected from the group consisting of polysulfone, polyethersulfone and polyarylsulfone. Examples of the preferred polysulfone polymer include polysulfone, polyethersulfone or polyarylsulfone having a repeating unit represented by Formula 1.

[Formula 1]

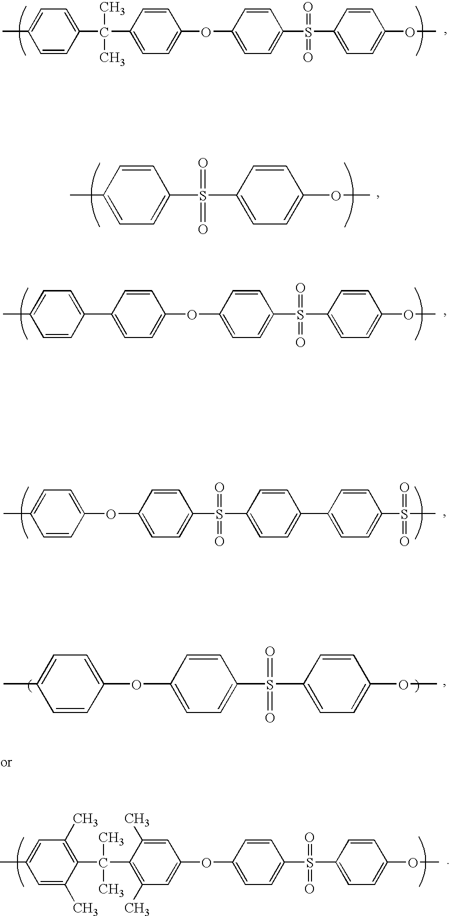

The weight average molecular weight of the polysulfone polymer is not particularly defined, but preferably 3,000˜200,000, and more preferably 10,000˜200,000. If the weight average molecular weight of the polysulfone polymer is less than 3,000, the mechanical and thermal properties thereof to be practically used are insufficient. If the weight average molecular weight of the polysulfone polymer is greater than 200,000, the solubility is lowered, deteriorating processibility of preparing a casting solution for the polymer membrane. However, even if the weight average molecular weight is greater than 200,000, there is no limitation in practical use of the polysulfone polymer, other than the above-stated processibility problem.

The poly(vinylpyrrolidone-co-styrene) copolymer includes any type of molecular structures obtainable from vinylpyrrolidone and styrene, for example, a random copolymer, block copolymer and graft copolymer of vinylpyrrolidone and styrene. Specifically, the random copolymer, which can be easily obtained by polymerization using a radical initiator is more preferred in view of cost efficiency.

The content ratio of vinylpyrrolidone residues of the poly(vinylpyrrolidone-co-styrene) copolymer, that is, the content ratio of vinylpyrrolidone residue to (vinypyrorlidone residue+styrene residue) is preferably in the range of 60 wt % ˜90 wt %. If the content of the vinylpyrrolidone residue of the poly(vinylpyrrolidone-co-styrene) copolymer is less than 60 wt %, the poly(vinylpyrrolidone-co-styrene) copolymer is insufficiently compatible with the polysulfone polymer, making it impossible to form a single phase blend. Also, since the hydrophilicity of the polymer membrane is insufficient, effects of increasing water permeability and preventing contamination of the filtration membrane are poor. If the content of the vinylpyrrolidone residue is greater than 90 wt %, the poly(vinylpyrrolidone-co-styrene) copolymer is insufficiently compatible with the polysulfone polymer, making it impossible to form a single phase blend, like in the case of shortage in the content. Further, since the hydrophilicity of the obtained polymer membrane is overly increased, the polymer membrane may be too much swollen by water.

The weight average molecular weight of the poly(vinylpyrrolidone-co-styrene) copolymer is not particularly defined, but preferably in the range of 3,000˜500,000, more preferably 10,000˜300,000. If the weight average molecular weight of the poly(vinylpyrrolidone-co-styrene) copolymer is less than 3,000, the mechanical and thermal properties thereof to be practically used are insufficient. If the weight average molecular weight of the poly(vinylpyrrolidone-co-styrene) copolymer is greater than 500,000, the solubility is lowered, deteriorating processibility of preparing a casting solution for the polymer membrane. However, even if the weight average molecular weight is greater than 500,000, there is no limitation in practical use of the poly(vinylpyrrolidone-co-styrene) copolymer, other than the above-stated processibility problem.

In the blend forming the polymer membrane according to the present invention, the content of the poly(vinylpyrrolidone-co-styrene) copolymer is preferably 3 wt %˜50 wt % based on the total weight of polysulfone polymer and poly(vinylpyrrolidone-co-styrene) copolymer combined. If the content of the poly(vinylpyrrolidone-co-styrene) copolymer is less than 3 wt %, water permeability is lowered and the effect of preventing contamination of the filtration membrane is inefficiently exerted. If the content of the poly(vinylpyrrolidone-co-styrene) copolymer is greater than 50 wt %, the mechanical and thermal properties of the filtration membrane deteriorate.

As described above, the polymer membrane according to the present invention is made of a single phase blend comprising a hydrophobic polysulfone polymer and a hydrophilic poly(vinylpyrrolidone-co-styrene) copolymer. Thus, the polymer membrane according to the present invention can be advantageously used as a filtration membrane for water treatment because it has good mechanical, thermal and chemical properties which are advantages of a polysulfone polymer, and also has excellent water permeability and fouling resistance exerted by a poly(vinylpyrrolidone-co-styrene) copolymer. Therefore, the polymer membrane made of a single phase blend according to the present invention can be advantageously used as an ultrafiltration membrane, a microfiltration membrane, a supporting layer of a reverse osmosis composite membrane, and the like.

A method of preparing the polymer membrane according to the present invention will now be described.

(1) Preparation of Copolymer

First, a hydrophillic monomer which can impart sufficient hydrophillicity to the resulting polymer membrane, and a hydrophobic comonomer compatible with a polysulfone polymer, were selected for copolymerization. Thus, it is possible to obtain a copolymer capable of forming a single phase blend with a hydrophobic polysulfone polymer and giving hydrophilicity to the polymer membrane to suitably function as a filtration membrane for water treatment.

In consideration of convenience of a subsequent polymerization process, suitable examples of the hydrophilic monomer include vinyl acetate, acrylic acid, methacrylic acid, acrylonitrile, vinyl pyrridine, vinyl pyrrolidone, polyethyleneglycol acrylate, polyethyleneglycol methacrylate, vinylsulfonic acid, sodium salts thereof, vinylimidazole, styrene sulfonic acid and sodium salts thereof.

Suitable examples of the hydrophobic comonomer include ethylene, propylene, styrene, α-methyl styrene, vinyl toluene, alkyl arylate, alkyl methacrylate, vinyl chloride, vinyl benzylchloride, vinylidene chloride, vinyl norbornene and the like.

A poly(vinylpyrrolidone-co-styrene) copolymer obtained by copolymerizing styrene as a hydrophobic monomer and vinyl pyrrolidone as a hydrophilic monomer in the above content ratio is preferably used in view of compatibility with a polysulfone polymer and appropriate hydrophilicity.

As the copolymerization method of the hydrophobic monomer and the hydrophilic monomer, an appropriate method well-known in the art including radical polymerization, anion polymerization or cation polymerization and the like is selected according to properties of monomer, and radical polymerization is preferred in view of economic efficiency and simplicity.

Suitable examples of the initiator used when using a radical polymerization method include peroxide-based initiators such as BPO (benzoyl peroxide), succinoyl peroxide, dilauroyl peroxide or dicumyl peroxide, and azo-based initiators such as AIBN (2,2-azo-bis-isobutyronitrile) or azo bis(2,4-dimethyl valeronitrile), and the useful amount thereof is preferably 0.001 to 10 wt % based on the total weight of the monomer.

Radical polymerization can be carried out by bulk polymerization, solution polymerization, emulsion polymerization, or suspension polymerization, and an appropriate method is selected according to properties of the monomer used.

(2) Preparation of Casting Solution

The thus prepared copolymer and a polysulfone polymer were well mixed using cosolvent of these materials, to give a homogenous casting solution. 3 wt %˜50 wt % of poly(vinylpyrrolidone-co-styrene) copolymer based on the total weight of polysulfone polymer and poly(vinylpyrrolidone-styrene combined was dissolved with the polysulfone polymer in an appropriate amount of a solvent. The total content of the two polymers were adjusted to be in the range of 10˜30 wt % based on the weight of the casting solution. If the total content is less than 10 wt %, the concentration of the casting solution is too small to prepare a filtration membrane. If the total content is greater than 30 wt %, the concentration of the casting solution is so great that the thickness of a film produced therefrom is overly increased, lowering the performance of the filtration membrane.

Suitable examples of the solvent used in preparing the casting solution using polysulfone polymer and poly(vinylpyrrolidone-co-styrene) copolymer include NMP (N-2-methyl-pyrrolidone), DMF (N,N-dimethylformamide), DMSO (dimethylsulfoxide), and DMAc (N,N-dimethylacetamide).

(3) Preparation of Polymer Membrane

The casting solution was cast on an appropriate substrate such as a glass plate or nonwoven fabric to give a polymer membrane. The thickness of the polymer membrane is preferably adjusted to be in the range of 0.5˜3 mm. If the thickness of the polymer membrane is less than 0.5 mm, it is quite difficult to form a polymer membrane. If the thickness of the polymer membrane is greater than 3 mm, the performance of the filtration membrane may deteriorate.

The thus obtained polymer membrane was immersed in a gelation bath to form pores on both surfaces of the polymer membrane. Here, a water bath is preferably used as the gelation bath. When the polymer membrane was immersed in the water bath, pores were formed at spaces produced when the organic solvent trapped into the polymer membrane was extracted, thereby obtaining a complete filtration membrane. The pores are interconnected between both surfaces of the polymer membrane to form flow channels. The flow channels form a reticulated network in the polymer membrane.

(4) Determination of Molecular Weight

In the present invention, molecular weights were measured by GPC (Gel Permeation Chromatography) as follows. A GPC system consisting of a reflective index detector (JASCO RI-1530), a High Performance Liquid Chromatography (HPLC) pump (JASCO PU-1580), and a column thermostat (JASCO CO-1560) was used. Measurement of molecular weights was carried out under the condition in which a solution obtained by dissolving a polymer to be measured in methylene chloride at a concentration of about 1 ppm was flowed into a Phenogel column (Phenomenex, US) for approximately 2 hours. The molecular weight measurement range of the column was in the range of 500˜1,000,000.

The present invention will now be described in detail with reference to the following examples. However, such examples are provided for better understanding of the invention and are not intended to limit the scope of the invention.

Synthesis of poly(vinylpyrrolidone-co-styrene) Copolymer

### EXAMPLE 1

80 wt % vinylpyrrolidone monomer, 20 wt % styrene monomer, and 0.05 wt % AIBN as an initiator based on the total weight of the two monomers, were mixed in a reactor and copolymerized at 60˜80° C. for approximately 24 hours, to prepare a poly(vinylpyrrolidone-co-styrene) copolymer. The thus prepared copolymer was sufficiently dried at a vacuum oven maintained at a temperature of approximately 80° C., the temperature was elevated to 120° C. and the resultant product was sufficiently dried for several days, to give a poly(vinylpyrrolidone-co-styrene) copolymer (to be referred to as “PVPS-A”).

The “PVPS-A” was subjected to elemental analysis to determine compositions of the copolymer. The analysis result showed that the amount of vinylpyrrolidone residue was approximately 70 wt %, and the amount of styrene residue was approximately 30 wt %.

### EXAMPLE 2

A poly(vinylpyrrolidone-co-styrene) copolymer (“PVPS-B”) was prepared by the same copolymerization method as in Example 1, except that the amounts of the vinylpyrrolidone monomer and the styrene monomer were 70 wt % and 30 wt %, respectively.

The “PVPS-B” was subjected to elemental analysis to determine compositions of the copolymer. The analysis result showed that the amount of vinylpyrrolidone residue was approximately 60 wt %, and the amount of styrene residue was approximately 40 wt %.

### EXAMPLE 3

A poly(vinylpyrrolidone-co-styrene) copolymer (“PVPS-C”) was prepared by the same copolymerization method as in Example 1, except that the amounts of the vinylpyrrolidone monomer and the styrene monomer were 30 wt % and 70 wt %, respectively.

The “PVPS-C” was subjected to elemental analysis to determine compositions of the copolymer. The analysis result showed that the amount of vinylpyrrolidone residue was approximately 20 wt %, and the amount of styrene residue was approximately 80 wt %.

### EXAMPLE 4

A poly(vinylpyrrolidone-co-styrene) copolymer (“PVPS-D”) was prepared by the same copolymerization method as in Example 1, except that the amounts of the vinylpyrrolidone monomer and the styrene monomer were 40 wt % and 60 wt %, respectively.

The “PVPS-D” was subjected to elemental analysis to determine compositions of the copolymer. The analysis result showed that the amount of vinylpyrrolidone residue was approximately 30 wt %, and the amount of styrene residue was approximately 70 wt %.

### EXAMPLE 5

A poly(vinylpyrrolidone-co-styrene) copolymer (“PVPS-E”) was prepared by the same copolymerization method as in Example. 1, except that the amounts of the vinylpyrrolidone monomer and the styrene monomer were 50 wt % and 50 wt %, respectively.

The “PVPS-E” was subjected to elemental analysis to determine compositions of the copolymer. The analysis result showed that the amount of vinylpyrrolidone residue was approximately 40 wt %, and the amount of styrene residue was approximately 60 wt %.

### EXAMPLE 6

A poly(vinylpyrrolidone-co-styrene) copolymer (“PVPS-F”) was prepared by the same copolymerization method as in Example 1, except that the amounts of the vinylpyrrolidone monomer and the styrene monomer were 60 wt % and 40 wt %, respectively.

The “PVPS-F” was subjected to elemental analysis to determine compositions of the copolymer. The analysis result showed that the amount of vinylpyrrolidone residue was approximately 50 wt %, and the amount of styrene residue was approximately 50 wt %.

### EXAMPLE 7

A poly(vinylpyrrolidone-co-styrene) copolymer (“PVPS-G”) was prepared by the same copolymerization method as in Example 1, except that the amounts of the vinylpyrrolidone monomer and the styrene monomer were 65 wt % and 35 wt %, respectively.

The “PVPS-G” was subjected to elemental analysis to determine compositions of the copolymer. The analysis result showed that the amount of vinylpyrrolidone residue was approximately 65 wt %, and the amount of styrene residue was approximately 35 wt %.

### EXAMPLE 8

A poly(vinylpyrrolidone-co-styrene) copolymer (“PVPS-H”) was prepared by the same copolymerization method as in Example 1, except that the amounts of the vinylpyrrolidone monomer and the styrene monomer were 85 wt % and 15 wt %, respectively.

The “PVPS-H” was subjected to elemental analysis to determine compositions of the copolymer. The analysis result showed that the amount of vinylpyrrolidone residue was approximately 80 wt %, and the amount of styrene residue was approximately 20 wt %.

### EXAMPLE 9

A poly(vinylpyrrolidone-co-styrene) copolymer (“PVPS-I”) was prepared by the same copolymerization method as in Example 1, except that the amounts of the vinylpyrrolidone monomer and the styrene monomer were 93 wt % and 7 wt %, respectively.

The “PVPS-J” was subjected to elemental analysis to determine compositions of the copolymer. The analysis result showed that the amount of vinylpyrrolidone residue was approximately 90 wt %, and the amount of styrene residue was approximately 10 wt %.

### EXAMPLE 10

A poly(vinylpyrrolidone-co-styrene) copolymer (“PVPS-J”) was prepared by the same copolymerization method as in Example 1, except that the amounts of the vinylpyrrolidone monomer and the styrene monomer were 95 wt % and 5 wt %, respectively.

The “PVPS-J” was subjected to elemental analysis to determine compositions of the copolymer. The analysis result showed that the amount of vinylpyrrolidone residue was approximately 92 wt %, and the amount of styrene residue was approximately 8 wt %.

Experimental Test of Formation of Single Phase Polymer Blend

### EXAMPLE 11

0.05 g (50 wt %) of PVPS-G containing 65 wt % vinyl pyrrolidone residue, prepared in Example 7, and 0.05 g (50 wt %) of polysulfone (Amoco, Udel P-1700) were dissolved in 99.9 g NMP and stirred to prepare a homogenous solution. The solution was cast and dried at a vacuum oven maintained at a temperature of 130° C. for approximately 24 hours, thereby obtaining a 0.02 mm thick transparent film.

A glass transition temperature of the film was measured using a differential scanning calorimeter (DSC-2010, TA Instrument) under the condition in which 10 mg of the film sample was allowed to stand at 220° C. for 5 minutes, cooled to approximately 25° C. at a scanning rate of 30° C./min, and then raised to 250° C. at a scanning rate of 10° C./min. The result showed that the film exhibited a glass transition at approximately 160° C., which is an intermediate value between the glass transition temperature of PVPS-G and the glass transition temperature of the bisphenol-A polysulfone, confirming that the resulting film was made of a single phase blend.

Films prepared by mixing PVPS-G with the polysulfone in amounts of 5 wt %, 30 wt %, 40 wt %, 60 wt %, 70 wt % and 95 wt % were all transparent and showed a single glass transition. The observation result confirmed that the PVPS-G polymer containing 65 wt % vinylpyrrolidone residue was miscible with the polysulfone to form a single phase polymer blend at a PVPS-G mixture ratio of 5 wt % ˜95 wt %. Also, it was observed that the both polymers formed a single phase polymer blend at mixture ratios other than the above PVPS-G contents of 5 wt % ˜95 wt %. Thus, it was confirmed that the both polymers formed a single phase polymer blend at all mixture ratios.

### EXAMPLE 12

A film obtained in the same manner as in Example 11 except that PVPS-H containing 80 wt % vinylpyrrolidone residue prepared in Example 8 and the polysulfone (Udel P-1700) were used, was subjected to observation of transparency and differential scanning calorimetry (DSC). The result showed that PVPS-H formed a single phase polymer blend with the polysulfone at all mixture ratios.

### EXAMPLE 13

A film obtained in the same manner as in Example 11 except that PVPS-I containing 90 wt % vinylpyrrolidone residue prepared in Example 9 and the polysulfone (Udel P-1700) were used, was subjected to observation of transparency and DSC. The result showed that PVPS-I formed a single phase polymer blend with polysulfone at all mixture ratios.

### EXAMPLE 14

A film obtained in the same manner as in Example 11 except that PVPS-F containing 50 wt % vinylpyrrolidone residue prepared in Example 6 and the polysulfone (Udel P-1700) were used, was subjected to observation of transparency and DSC. The transparency observation result showed that the film was opaque. The DSC resulting showed that the film showed two glass transitions corresponding to the two polymers. Thus, it was confirmed that the resulting film was made of two phase blend rather than a single phase blend.

### EXAMPLE 15

A film obtained in the same manner as in Example 11 except that PVPS-D containing 30 wt % vinylpyrrolidone residue prepared in Example 4 and the polysulfone (Udel P-1700) were used, was subjected to observation of transparency and DSC. The transparency observation resulting showed that the film was opaque at all mixture ratios. The DSC resulting showed that the film showed two glass transitions corresponding to the two polymers. Thus, it was confirmed that the resulting film was made of a two phase blend rather than a single phase blend.

### EXAMPLE 16

A film obtained in the same manner as in Example 11 except that PVPS-H containing 80 wt % vinylpyrrolidone residue prepared in Example 8 and polyethersulfone (Victrex, ICI Americas, Inc.) were used, was subjected to observation of transparency and DSC. The results showed that PVPS-H formed a single phase blend with the polyethersulfone at all mixture ratios.

### EXAMPLE 17

A film obtained in the same manner as in Example 11 except that PVPS-D containing 30 wt % vinylpyrrolidone residue prepared in Example 4 and the polyethersulfone (Victrex) were used, was subjected to observation of transparency and DSC. The transparency observation resulting showed that the film was opaque at all mixture ratios. The DSC resulting showed that the film showed two glass transitions corresponding to the two polymers. Thus, it was confirmed that the resulting film was made of a two phase blend rather than a single phase blend.

### EXAMPLE 18

A film obtained in the same manner as in Example 11 except that PVPS-A containing 70 wt % vinylpyrrolidone residue prepared in Example 1 and tetramethylbisphenol-A polysulfone were used, was subjected to observation of transparency and DSC. The results showed that PVPS-A formed a single phase blend with the tetramethylbisphenol-A polysulfone at all mixture ratios.

The results for Examples 1˜18 showed that feasibility of forming a single phase blend from both polymers was determined according to the chemical structure of a polysulfone-based polymer used and a change in the amount of vinyl pyrrolidone residue contained in the poly(vinylpyrrolidone-co-styrene) copolymer. According to the examples, polysulfone formed a single phase blend when the amount of vinyl pyrrolidone residue contained in the poly(vinylpyrrolidone-co-styrene) copolymer was in the range of 65 wt %˜90 wt %, the polyethersulfone formed a single phase blend when the amount of vinyl pyrrolidone residue contained in the poly(vinylpyrrolidone-co-styrene) copolymer was in the range of 60 wt % ˜90 wt %, and the tetramethylbisphenol-A polysulfone formed a single phase blend when the amount of vinyl pyrrolidone residue contained in the poly(vinylpyrrolidone-co-styrene) copolymer was in the range of 70 wt %˜80 wt %.

The tetramethylbisphenol-A polysulfone was synthesized as follows.

63.36 g (222.8 mmol) 3,3′,5,5′-tetramethyl bisphenol A, 56.65 g (222.8 mmol) 4,4′-difluorodiphenyl sulfone, and 46.56 g (300.7 mmol) K₂CO₃ were added to a mixed solvent of 400 ml NMP and 200 ml toluene, and stirred until the monomers were dissolved. While stirring, the reaction temperature was slowly raised to 140˜150° C., and water and toluene contained in the resultant solution were evaporated for 6˜7 hours. Then, the reaction temperature was raised to 180˜188° C., and the reaction was further carried out for approximately 4 hours. The temperature of the resulting solution was lowered to approximately 50° C., followed by adding 20 ml glacial acetic acid thereto, and then the reaction was terminated. The resulting product was filtered and washed, dried at a vacuum oven maintained at a temperature of approximately 55° C. for over 24 hours, giving tetramethylbisphenol-A polysulfone at a yield of approximately 92%.

The following examples demonstrate compared performance as a filtration membrane between the polymer membrane made of a single phase blend according to the present invention and a conventional polymer membrane made of only a polysulfone polymer.

### EXAMPLE 19

5 g PVPS-A containing 70 wt % vinylpyrrolidone residue and 17 g polysulfone (Udel P-1700) were dissolved in a 78 g NMP solvent to give a homogenous casting solution A. Separately, 22 g polysulfone (Udel P-1700) was dissoved in a 78 g NMP solvent to give a homogenous casting solution B.

The obtained casting solutions A and B were cast on separate nonwoven fabrics to give polymer membranes, respectively. The casting films were immersed in a water bath for 24 hours to prepare two 0.15 mm thick polymer membranes.

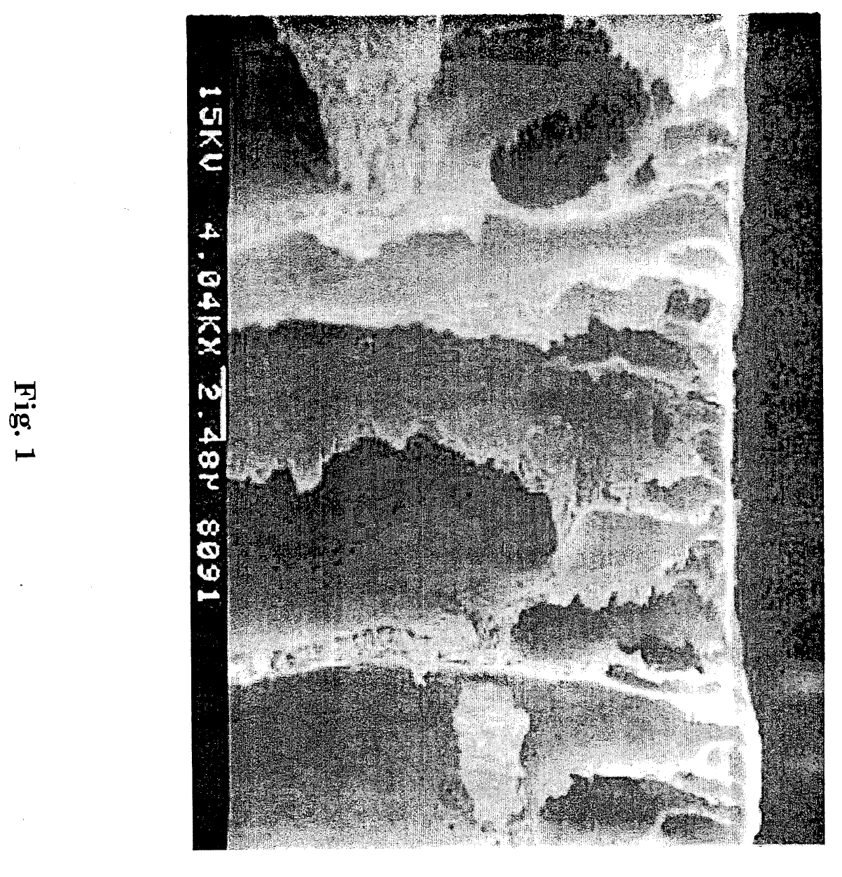

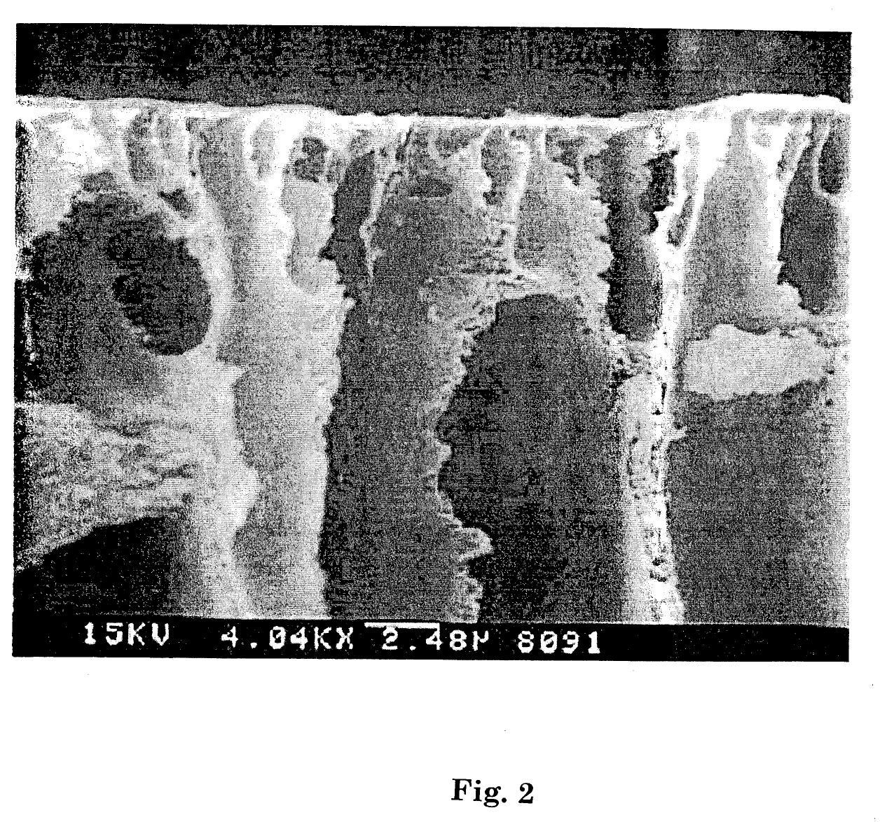

FIG. 1 is a scanning electron micrograph of the cross section of the polysulfone membrane prepared from the casting solution B, and FIG. 2 is a scanning electron micrograph of the cross section of the single phase polymer membrane prepared from the casting solution A, according to the present invention.

Referring to FIGS. 1 and 2, the filtration membrane according to the present invention shown in FIG. 2 is in a single phase, like the filtration membrane made of only the polysulfone polymer, and a micropore network is formed in the single phase polymer membrane.

In order to evaluate performance of each of the two polymer membranes as a filtration membrane, molecular weight cut-off and water permeability were examined with the polymer membranes. The molecular weight cut-off of each membrane was measured using a 1000 ppm poly(ethylene glycol) (PEG) aqueous solution. The measurement result showed that both polymer membranes removed over 95 wt % of PEG having a weight average molecular weight of 20,000. In the case of water permeability, the single phase polymer membrane prepared from the casting solution A according to the present invention had water permeability of approximately 14.3 l/m²·atm·hr, while the conventional polymer membrane prepared from the casting solution B had water permeability of approximately 5.7 l/m²·atm·hr. That is to say, the polymer membrane according to the present invention exhibited approximately 2.5 time of water permeability compared to the conventional polymer membrane.

### EXAMPLE 20

A polymer membrane was prepared in the same manner as in Example 19 except that 5 g PVPS-D instead of 5 g of PVPS-A.

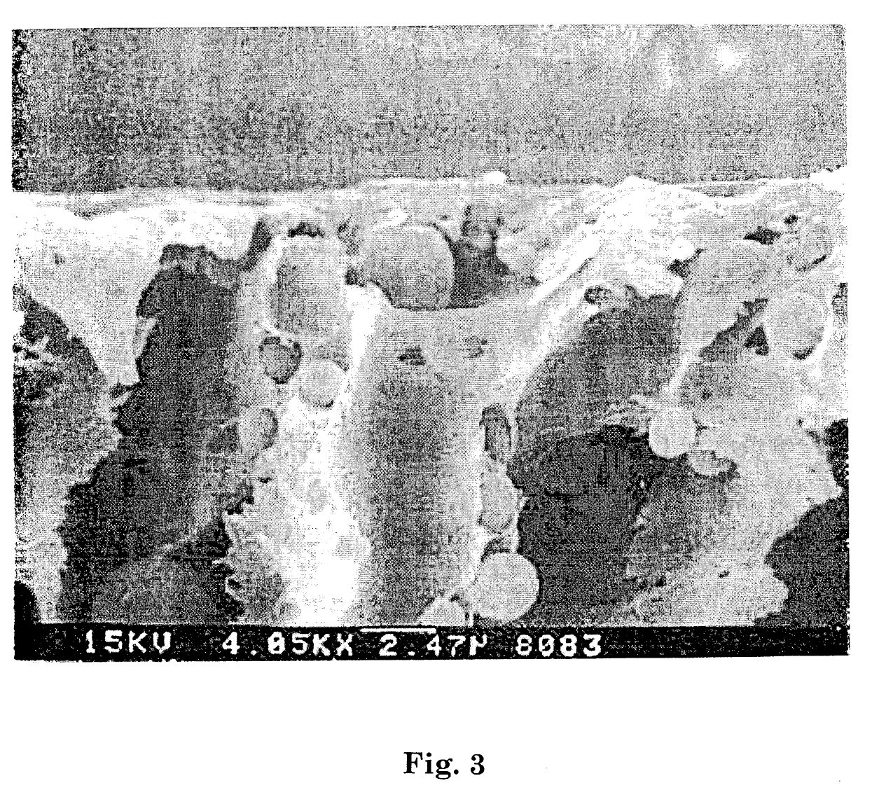

FIG. 3 is a scanning electron micrograph of the cross section of the filtration membrane prepared from the casting solution.

Referring to FIG. 3, the polymer membrane showed phase separation between polysulfone and poly(vinylpyrrolidone-styrene), suggesting the membrane was made of a two phase blend rather than a single phase blend.

The resulting polymer membrane had water permeability of approximately 23.0 l/m²·atm·hr, that is, approximately 4 times, compared to that of the conventional polysulfone polymer membrane prepared from the casting solution B of Example 19. However, as to solute removing efficiency, only 7 wt % of PEG having a weight average molecular weight of 20,000 was removed. That is, compared to the conventional polymer membrane formed of only polysulfone, the solute removing efficiency of the polymer membrane according to Example 20 was considerably reduced.

### EXAMPLE 21

A polymer membrane was prepared in the same manner as in Example 19 except that 11 g polysulfone and 11 g PVPS-D containing 70 wt % vinylpyrrolidone residue were used.

The scanning electron micrograph of the cross section of the resulting polymer membrane confirmed that it was in a single phase. Also, the measurement result of the molecular weight cut-off of the polymer membrane showed that approximately 95 wt % of PEG having a weight average molecular weight of 20,000 was removed, suggesting that the solute removing efficiency of the polymer membrane is substantially the same that of the polysulfone membrane. The resulting polymer membrane had water permeability of approximately 26 l/m²·atm·hr, that is, approximately 4.5 times, compared to that of the conventional polysulfone polymer membrane.

### EXAMPLE 22

A polymer membrane was prepared in the same manner as in Example 19 except that 11 g polyethersulfone (Victrex) and 5 g PVPS-H containing 80 wt % vinylpyrrolidone residue were used.

The scanning electron micrograph of the cross section of the resulting polymer membrane confirmed that it was in a single phase. Also, the resulting polymer membrane had substantially the same solute removing efficiency as that of the polysulfone membrane, like the polymer membrane of Example 21. The resulting polymer membrane had water permeability of approximately 17 l/m²·atm·hr, that is, approximately 3 times, compared to that of the conventional polysulfone polymer membrane.

### EXAMPLE 23

A polymer membrane was prepared in the same manner as in Example 19 except that 11 g polyethersulfone (Victrex) and 5 g PVPS-H containing 80 wt % vinylpyrrolidone residue were used.

The scanning electron micrograph of the cross section of the resulting polymer membrane confirmed that it was in a single phase. Also, the resulting polymer membrane had substantially the same solute removing efficiency as that of the polysulfone membrane, like the polymer membrane of Example 21. The resulting polymer membrane had water permeability of approximately 31.5 l/m²·atm ·hr, that is, approximately 5.5 times, compared to that of the conventional polysulfone polymer membrane.

### EXAMPLE 24

A polymer membrane was prepared in the same manner as in Example 19 except that 17 g tetramethylbisphenol-A polysulfone and 5 g PVPS-A containing 70 wt % vinylpyrrolidone residue were used.

The scanning electron micrograph of the cross section of the resulting polymer membrane confirmed that it was in a single phase. Also, the resulting polymer membrane had substantially the same solute removing efficiency as that of the polysulfone membrane, like the polymer membrane of Example 21. The resulting polymer membrane had water permeability of approximately 22.2 l/m²·atm ·hr, that is, approximately 3.5 times, compared to that of the conventional polysulfone polymer membrane.

### EXAMPLE 25

A polymer membrane was prepared in the same manner as in Example 19 except that 17 g bisphenol-A polysulfone and 5 g PVPS-A containing 70 wt % vinylpyrrolidone residue were used.

A change in the performance of the resulting polymer membrane was observed over use time. The observation result showed that approximately 30% of water permeability of the conventional polysulfone membrane decreased after the use for 2 months, while the polymer membrane according Example 25 exhibited a reduction of only approximately 10%, compared to the initial level of the water permeability.

Thus, the polymer membrane made of a single phase blend according to the present invention has much better fouling resistance than the conventional polysulfone polymer membrane.

### EXAMPLE 26

A polymer membrane was prepared in the same manner as in Example 19 except that 11 g bisphenol-A polysulfone and 11 g PVPS-A containing 70 wt % vinylpyrrolidone residue were used.

A change in the performance of the resulting polymer membrane was observed over use time. The observation result showed that approximately 30% of water permeability of the conventional polysulfone membrane decreased after the use for 2 months, while the polymer membrane according to Example 26 exhibited a reduction of only approximately 5%, compared to the initial level of the water permeability.

Thus, the polymer membrane made of a single phase blend according to the present invention has much better fouling resistance than the conventional polysulfone polymer membrane.

As described above, a polymer membrane according to the present invention made of single phase blend of a polysulfone polymer and poly(vinylpyrrolidone-co-styrene) copolymer renders hydrophilicity to the conventional polysulfone membrane. Thus, 2.5 to 5.5 times of water permeability increases without a reduction in solute removing efficiency and fouling resistance is also enhanced, thereby considerably preventing contamination of the filtration membrane occurring when it is used as a filtration membrane water treatment for a prolonged time. Therefore, if the polymer membrane according to the present invention is used as a filtration membrane for water treatment, the processing efficiency of ultrafiltration or microfiltration can be greatly increased. Also, if the polymer membrane according to the present invention is used as a supporting layer of a reverse osmosis composite membrane, a an immersion time of an amine aqueous solution can be considerably reduced, thereby greatly reducing the manufacturing cost of the reverse osmosis composite membrane.

What is claimed is:

1. A polymer membrane having a first surface and a second surface, wherein the polymer membrane has a reticulated network of flow channels between pores on the first and second surfaces, and is made of a single phase blend containing a polysulfone polymer and a poly(vinylpyrrolidone-co-styrene) copolymer, the content of the poly(vinylpyrrolidone-co-styrene) copolymer contained in the polymer membrane being such that the poly(vinylpyrrolidone-co-styrene) copolymer can form the single phase blend with the polysulfone polymer.

2. The polymer membrane of claim 1 wherein the polysulfone polymer is selected from the group consisting of polysulfone, polyethersulfone, and polyarylsulfone.

3. The polymer membrane of claim 1, wherein the sulfone polymer has a repeating unit of polysulfone, polyethersulfone or polyarylsulfone polymer represented by Formula 1:
<Formula 1>

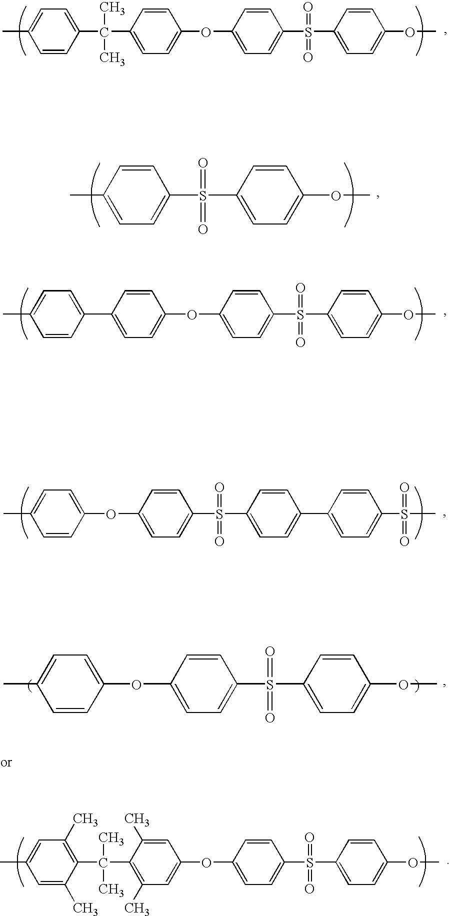

4. The polymer membrane of claim 1, wherein the content ratio of vinylpyrrolidone residue of the poly(vinylpyrrolidone-co-styrene) copolymer is in the range of 60 wt % ˜90 wt %.

5. The polymer membrane of claim 1, wherein the amount of the poly(vinylpyrrolidone-co-styrene) copolymer contained in the blend is in the range of 3 wt % ˜50 wt % based on the total weight of polysulfone polymer and poly(vinylpyrrolidone-co-styrene) copolymer combined.

6. The polymer membrane of claim 1, wherein the polysulfone polymer has a weight average molecular weight in the range of 3,000˜200,000.

7. The polymer membrane of claim 1, wherein the poly(vinylpyrrolidone-co-styrene) copolymer has a weight average molecular weight in the range of 3,000˜500,000.

8. A filtering apparatus having a filter comprising a single phase polymer membrane defined in any one of claims 1 through 7, and used for ultrafiltration, microfiltration or reverse osmosis.
